(19) United States
(12) Patent Application Publication
(10) Pub. No.: US 2012/0144192 A1
(43) Pub. Date: Jun. 7, 2012

(54) METHOD, DEVICE, AND SYSTEM FOR MANAGING PERMISSION INFORMATION

(75) Inventors: Liangde CHEN, Shenzhen (CN); Chunmao LI, Shenzhen (CN); Jian YU, Shenzhen (CN); Xiuhua LIU, Shenzhen (CN)

(73) Assignee: CHENGDU HUAWEI SYMANTEC TECHNOLOGIES CO., LTD., Chengdu (CN)

(21) Appl. No.: 13/396,347

(22) Filed: Feb. 14, 2012

Related U.S. Application Data
(63) Continuation of application No. PCT/CN2010/075954, filed on Aug. 13, 2010.

(30) Foreign Application Priority Data
Aug. 14, 2009 (CN) 200910091254.8

(51) Int. Cl. G06F 21/00

(52) U.S. Cl. 713/165; 726/4

(57) ABSTRACT

A method, a device, and a system for managing permission information are provided. The method includes: receiving a permission modification instruction, where the permission modification instruction is used to instruct modification of permission information of a file; modifying the permission information according to the permission modification instruction of the file; and sending an Identifier (ID) of the file and the modified permission information to a server. The device includes: a modification module, a processing module, and a first sending module. The system includes: a client and a server. The server and the file jointly store the permission information, thereby effectively improving the flexibility of file encryption, reducing the burden of the server, and improving the performance of the server.

### CROSS-REFERENCE TO RELATED APPLICATION

This application is a continuation of International Application PCT/CN2010/075954, filed on Aug. 13, 2010, which claims priority to Chinese Patent Application No. 200910091254.8, filed on Aug. 14, 2009, both of which are hereby incorporated by reference in its entirety.

### FIELD OF THE INVENTION

The present invention relates to the field of communications, and in particular, to a method, a device, and a system for managing permission information.

### BACKGROUND OF THE INVENTION

A file encryption system is a system deployed by an enterprise to ensure security of internal information. The file encryption system generally includes a server and a client. The server is configured to save information of users and permission information of files. The client is configured to perform file encryption and file decryption. In the file encryption system, each time a file is created, an author or a designated user having re-authentication permission generally needs to set file permission at the client. The permission may be classified into multiple levels according to users of different kinds, for example, individuals, departments, or workgroups. For example, the permission of a file may be classified into levels of “read”, “edit”, “print”, and “complete control”. After authentication and encryption, a user not having any permission cannot open the file, and a user having certain level permission can decrypt the file through the client to perform operations allowed by the permission.

In the prior art, permission information of a file is stored in two manners. In one manner, the permission information is stored inside the file, and is then encrypted. A client receiving the file first needs to send the encrypted permission information to a server, then receives decrypted permission information from the server, and then performs subsequent operations on the file. In the other manner, the permission information of the file is stored in the server. The client receiving the file retrieves the permission information of the file from the server when opening the file, and performs subsequent operations on the file after receiving the permission information from the server.

During the implementation of the present invention, the inventors find that in the prior art, for the manner in which the permission information is stored inside the file, the permission information cannot be modified after the file is sent since the permission information is stored inside the file, which reduces the flexibility of file encryption; and for the manner in which the permission information of the file is stored in a server, the server stores permission information of a large number of files, which greatly increases the burden of the server and affects the performance of the server.

### SUMMARY OF THE INVENTION

Embodiments of the present invention provide a method, a device, and a system for managing permission information, so as to improve the flexibility of file encryption, reduce the burden of a server, and improve the performance of the server.

An embodiment of the present invention provides a method for managing permission information, where the method includes:

modifying permission information according to a permission modification instruction of a file;

adding the modified permission information into the file, and performing encryption processing on the file; and

sending an Identifier (ID) of the file and the modified permission information to a server, so that the server queries according to the ID whether permission information corresponding to the ID already exists in the server, replaces the permission information corresponding to the ID with the modified permission information if the permission information corresponding to the ID exists, or stores the modified permission information if the permission information corresponding to the ID does not exist.

An embodiment of the present invention further provides a method for managing permission information, where the method includes:

receiving an ID of a file and permission information sent by a client;

querying whether permission information corresponding to the received ID of the file already exists;

if the permission information corresponding to the ID already exists, performing decryption processing on the permission information corresponding to the ID;

if the permission information corresponding to the ID does not exist, performing decryption processing on the received permission information; and

sending the decrypted permission information to the client.

An embodiment of the present invention provides a device for managing permission information, where the device includes:

a modification module, configured to modify permission information according to a permission modification instruction of a file;

a processing module, configured to add the permission information modified by the modification module into the file, and perform encryption processing on the file; and

a first sending module, configured to send an ID of the file and the permission information modified by the modification module to a server, so that the server queries according to the ID whether permission information corresponding to the ID already exists in the server, replaces the permission information corresponding to the ID with the modified permission information if the permission information corresponding to the ID exists, or stores the modified permission information if the permission information corresponding to the ID does not exist.

An embodiment of the present invention further provides a device for managing permission information, where the device includes:

a second receiving module, configured to receive an ID of a file and permission information sent by a client;

a query module, configured to query whether permission information corresponding to the received ID already exists;

a first decryption module, configured to perform decryption processing on the permission information corresponding to the ID if the permission information corresponding to the ID already exists;

a second decryption module, configured to perform decryption processing on the received permission information if the permission information corresponding to the ID does not exist; and

a second sending module, configured to send the permission information decrypted by the first decryption module and the second decryption module to the client.

An embodiment of the present invention provides a system for managing permission information, where the system includes:

a client, configured to modify permission information according to a permission modification instruction of a file; add the modified permission information into the file, and perform encryption processing on the file; and send an ID of the file and the modified permission information; and

a server, configured to receive the ID of the file and the modified permission information sent by the client, query according to the ID whether permission information corresponding to the ID already exists in the server, replace the permission information corresponding to the ID with the modified permission information if the permission information corresponding to the ID exists, or store the modified permission information if the permission information corresponding to the ID does not exist.

An embodiment of the present invention further provides a system for managing permission information, where the system includes:

a client, configured to receive an encrypted file, and acquire and send an ID of the file and permission information; and

a server, configured to receive the ID of the file and the permission information sent by the client, query whether permission information corresponding to the received ID already exists, perform decryption processing on the permission information corresponding to the ID if the permission information corresponding to the ID already exists, perform decryption processing on the received permission information if the permission information corresponding to the ID does not exist, and send the decrypted permission information to the client.

In the method, device, and system for managing permission information according to the embodiments of the present invention, the server and the file jointly store the permission information, thereby effectively improving the flexibility of file encryption, reducing the burden of the server, and improving the performance of the server.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. It would be apparent to one of ordinary skill in the art that the accompanying drawings described herein are only some embodiments of the present invention, and persons of ordinary skill in the art can derive other drawings from the accompanying drawings without creative efforts.

FIG. 1 is a flow chart of a first embodiment of a method for managing permission information according to the present invention;

FIG. 2 is a flow chart of a second embodiment of a method for managing permission information according to the present invention;

FIG. 3 is a flow chart of a first specific embodiment of a method for managing permission information according to the present invention;

FIG. 4 is a flow chart of a second specific embodiment of a method for managing permission information according to the present invention;

FIG. 5 is a schematic structure diagram of a first embodiment of a device for managing permission information according to the present invention;

FIG. 6 is a schematic structure diagram of a second embodiment of a device for managing permission information according to the present invention;

FIG. 7 is a schematic structure diagram of a third embodiment of a device for managing permission information according to the present invention;

FIG. 8 is a system block diagram of a first embodiment of a system for managing permission information according to the present invention;

FIG. 9 is a flow chart of a third embodiment of a method for managing permission information according to the present invention; and

FIG. 10 is a schematic structure diagram of a fourth embodiment of a device for managing permission information according to the present invention.

### DETAILED DESCRIPTION OF THE EMBODIMENTS

The technical solutions of the present invention will be clearly and completely described in the following with reference to the accompanying drawings. It is obvious that the embodiments described herein are only a part rather than all of the embodiments of the present invention. All other embodiments obtained by persons of ordinary skill in the art based on the embodiments of the present invention without creative efforts shall fall within the protection scope of the present invention.

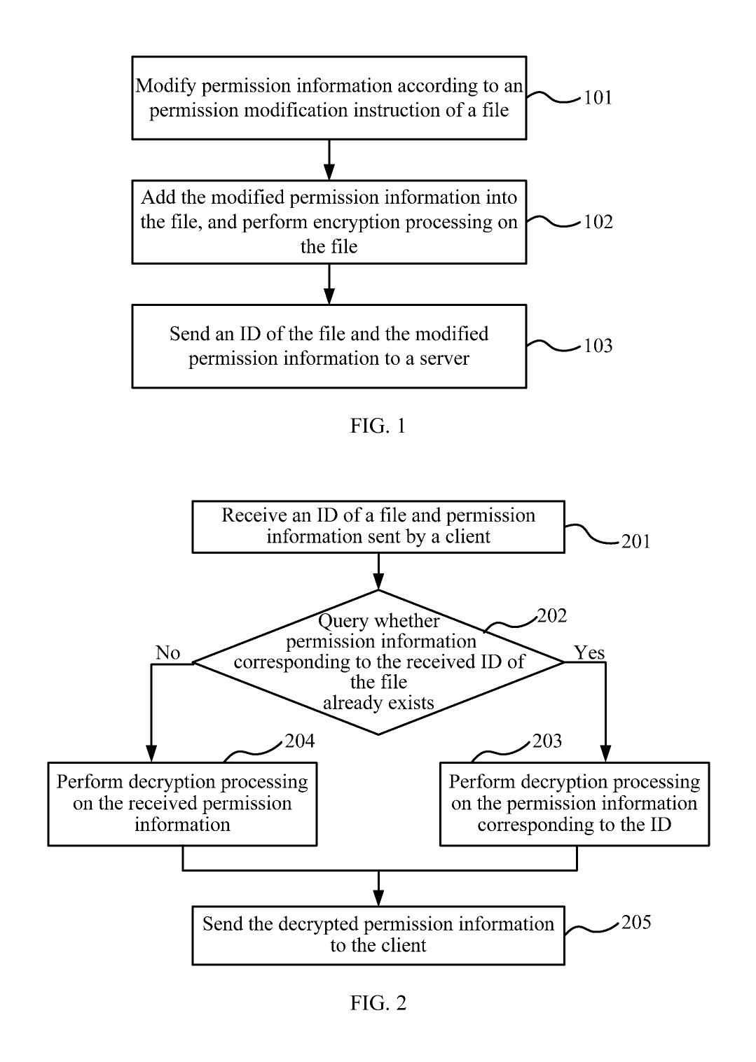

FIG. 1 is a flow chart of a first embodiment of a method for managing permission information according to the present invention. As shown in FIG. 1, according to the embodiment of the present invention, a method for managing permission information is provided, which includes the following steps.

Step 101: Modify permission information according to a permission modification instruction of a file.

Step 102: Add the modified permission information into the file, and perform encryption processing on the file.

Step 103: Send an ID of the file and the modified permission information to a server, so that the server queries according to the ID whether permission information corresponding to the ID already exists in the server, replaces the permission information corresponding to the ID with the modified permission information if the permission information corresponding to the ID exists, or stores the modified permission information if the permission information corresponding to the ID does not exist.

Step 102 is an optional step, that is, the permission information is not required to be added into the file, and the encryption processing is not required to be performed on the file.

In the embodiment of the present invention, the aforementioned steps may be executed by a client. When an author of a file or a designated user having re-authentication permission to the file intends to modify permission of the file, the author or the user sends a permission modification instruction to the client, and the client modifies permission information according to the permission modification instruction of the file. Then, the modified permission information is added into the file, and encryption processing is performed on the file. The encrypted file is divided into two parts. One part is a header file including the permission information and an ID of the file. The other part is contents of the file. Finally, the ID of the file and the modified permission information are sent to the server. The server stores the latest modified permission information according to the received ID.

In the method for managing permission information according to the embodiment of the present invention, the server and the file jointly store the permission information, and the modified permission information is stored in the server, thereby effectively improving the flexibility of file encryption, reducing the burden of the server, and improving the performance of the server.

In the first embodiment of the method, before step 101 the method may further include: receiving the permission modification instruction, where the permission modification instruction is used to instruct modification of the permission information of the file. The step may be executed by the client.

FIG. 2 is a flow chart of a second embodiment of a method for managing permission information according to the present invention. As shown in FIG. 2, according to the embodiment of the present invention, a method for managing permission information is further provided, which includes the following steps.

Step 201: Receive an ID of a file and permission information sent by a client.

Step 202: Query whether permission information corresponding to the received ID of the file already exists. If the permission information corresponding to the received ID of the file exists, the procedure proceeds to step 203, and if the permission information corresponding to the received ID of the file does not exist, the procedure proceeds to step 204.

Step 203: Perform decryption processing on the permission information corresponding to the ID. The procedure proceeds to step 205.

Step 204: Perform decryption processing on the received permission information. The procedure proceeds to step 205.

Step 205: Send the decrypted permission information to the client.

In the embodiment of the present invention, the aforementioned steps may be executed by a server. When the permission information corresponding to the received ID exists in the server, the permission information corresponding to the ID is the latest modified permission information of the ID, so that the latest modified permission information is sent to the client. When the permission information corresponding to the ID does not exist in the server, it indicates that the permission information is not modified by an author of the file or a designated user having re-authentication permission to the file, so that the decryption processing is performed on the received permission information, and the decrypted permission information is sent to the client.

In the method for managing permission information according to the embodiment of the present invention, the server and the file jointly store the permission information, the modified permission information is stored in the server, and the unmodified permission information is stored in the file, thereby effectively improving the flexibility of file encryption, reducing the burden of the server, and improving the performance of the server.

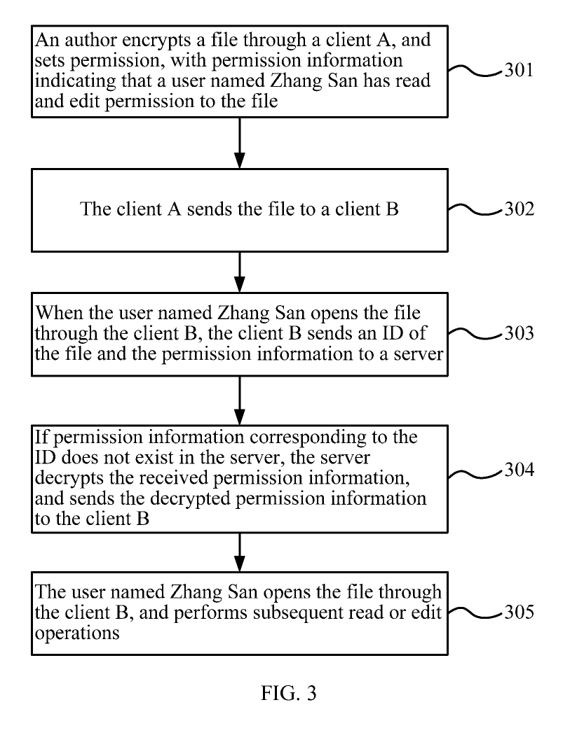

FIG. 3 is a flow chart of a first specific embodiment of a method for managing permission information according to the present invention. As shown in FIG. 3, according to the embodiment of the present invention, a method for managing permission information is provided, which includes the following steps.

Step 301: An author encrypts a file through a client A, and sets permission, with permission information indicating that a user named Zhang San has read and edit permission to the file.

Step 302: The client A sends the file to a client B.

Step 303: When the user named Zhang San opens the file through the client B, the client B sends an ID of the file and the permission information to a server.

Step 304: If permission information corresponding to the ID does not exist in the server, the server decrypts the received permission information, and sends the decrypted permission information to the client B.

Step 305: The user named Zhang San opens the file through the client B, and performs subsequent read or edit operations.

In the method for managing permission information according to the embodiment of the present invention, the server and the file jointly store the permission information, and when the permission information is not modified, the server directly decrypts the received permission information, thereby effectively improving the flexibility of file encryption, reducing the burden of the server, and improving the performance of the server.

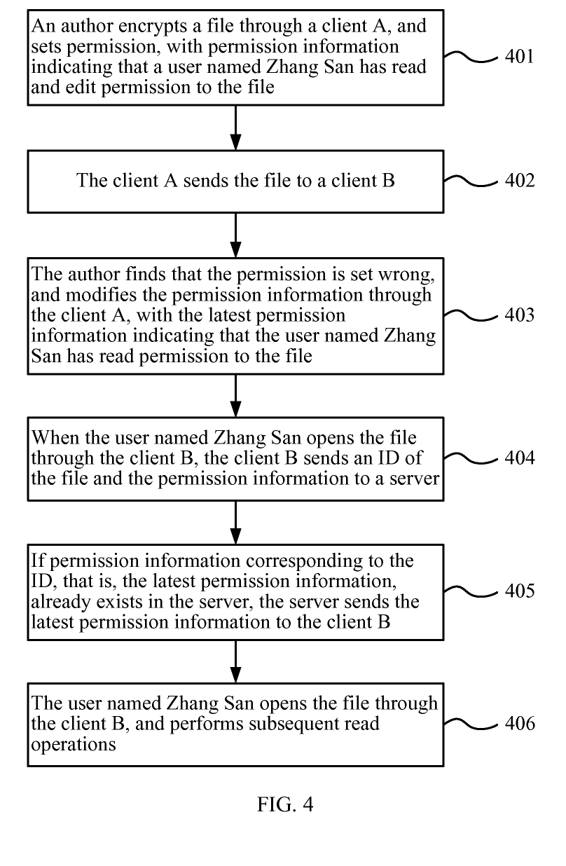

FIG. 4 is a flow chart of a second specific embodiment of a method for managing permission information according to the present invention. As shown in FIG. 4, according to the embodiment of the present invention, a method for managing permission information is provided, which includes the following steps.

Step 401: An author encrypts a file through a client A, and sets permission, with permission information indicating that a user named Zhang San has read and edit permission to the file.

Step 402: The client A sends the file to a client B.

Step 403: The author finds that the permission is set wrong, and modifies the permission information through the client A, with the latest permission information indicating that the user named Zhang San has read permission to the file.

Step 404: When the user named Zhang San opens the file through the client B, the client B sends an ID of the file and the permission information to a server.

Step 405: If permission information corresponding to the ID, that is, the latest permission information, already exists in the server, the server sends the latest permission information to the client B.

Step 406: The user named Zhang San opens the file through the client B, and performs subsequent read operations.

In the method for managing permission information according to the embodiment of the present invention, the server and the file jointly store the permission information, and when the permission information is modified, the server sends the latest modified permission information, thereby effectively improving the flexibility of file encryption, reducing the burden of the server, and improving the performance of the server.

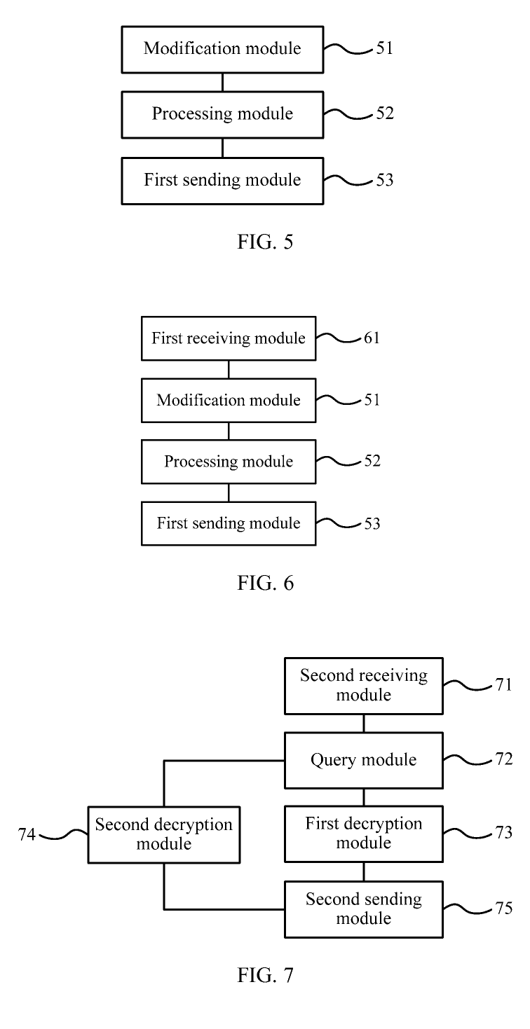

FIG. 5 is a schematic structure diagram of a first embodiment of a device for managing permission information according to the present invention. As shown in FIG. 5, according to the embodiment of the present invention, a device for managing permission information is provided, which includes a modification module 51, a processing module 52, and a first sending module 53. The modification module 51 is configured to modify permission information according to a permission modification instruction of a file. The processing module 52 is configured to add the permission information modified by the modification module 51 into the file, and perform encryption processing on the file. The first sending module 53 is configured to send an ID of the file and the permission information modified by the modification module 52 to a server, so that the server queries according to the ID whether permission information corresponding to the ID already exists in the server, replaces the permission information corresponding to the ID with the modified permission information if the permission information corresponding to the ID exists, or stores the modified permission information if the permission information corresponding to the ID does not exist.

The processing module 52 is an optional module, that is, the permission information is not required to be added into the file, and the encryption processing is not required to be performed on the file.

According to the embodiment of the present invention, when an author of a file or a designated user having re-authentication permission to the file intends to modify permission to the file, the author or the user sends a permission modification instruction to the client, and the modification module 51 modifies the permission information according to the received permission modification instruction. Then, the processing module 52 adds the modified permission information into the file, and performs encryption processing on the file. Finally, the first sending module 53 sends the ID of the file and the modified permission information to the server. The server stores the latest modified permission information according to the received ID.

In the device for managing permission information according to the embodiment of the present invention, the server and the file jointly store the permission information, and the modified permission information is stored in the server, thereby effectively improving the flexibility of file encryption, reducing the burden of the server, and improving the performance of the server.

FIG. 6 is a schematic structure diagram of a second embodiment of a device for managing permission information according to the present invention. As shown in FIG. 6, based on the first embodiment of the device, a device for managing permission information according to the present invention may further include a first receiving module 61. The first receiving module 61 is configured to receive a permission modification instruction, where the permission modification instruction is used to instruct modification of permission information of a file.

In the device for managing permission information according to the embodiment of the present invention, the server and the file jointly store the permission information, and the modified permission information is stored in the server, thereby effectively improving the flexibility of file encryption, reducing the burden of the server, and improving the performance of the server.

FIG. 7 is a schematic structure diagram of a third embodiment of a device for managing permission information according to the present invention. As shown in FIG. 7, according to the embodiment of the present invention, a device for managing permission information is provided, which includes a second receiving module 71, a query module 72, a first decryption module 73, a second decryption module 74, and a second sending module 75. The second receiving module 71 is configured to receive an ID of a file and permission information sent by a client. The query module 72 is configured to query whether permission information corresponding to the received ID already exists. The first decryption module 73 is configured to perform decryption processing on the permission information corresponding to the ID if the permission information corresponding to the ID already exists. The second decryption module 74 is configured to perform decryption processing on the received permission information if the permission information corresponding to the ID does not exist. The second sending module 75 is configured to send the permission information decrypted by the first decryption module 73 and the second decryption module 74 to the client.

According to the embodiment of the present invention, when the query module 72 finds that the permission information corresponding to the received ID exists in the server, the permission information corresponding to the ID is the latest modified permission information of the ID, so that the first decryption module 73 performs decryption processing on the latest modified permission information. When the query module 72 finds that the permission information corresponding to the ID does not exist in the server, it indicates that the permission information is not modified by an author of the file or a designated user having re-authentication permission to the file, so that the second decryption module 74 performs decryption processing on the received permission information, and then the second sending module 75 sends the decrypted permission information to the client.

In the device for managing permission information according to the embodiment of the present invention, the server and the file jointly store the permission information, thereby effectively improving the flexibility of file encryption, reducing the burden of the server, and improving the performance of the server.

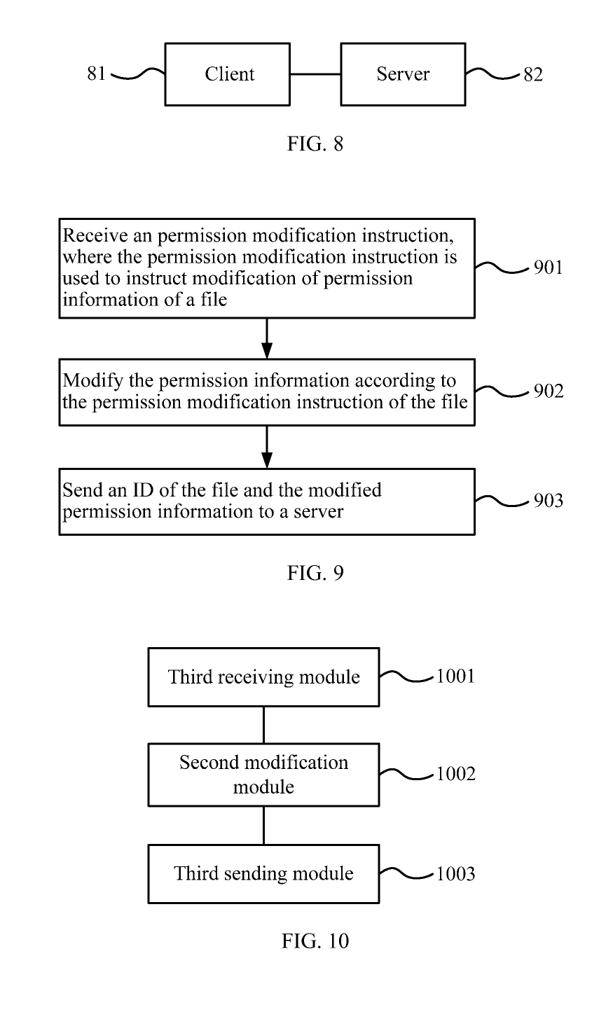

FIG. 8 is a system block diagram of a first embodiment of a system for managing permission information according to the present invention. As shown in FIG. 8, according to the embodiment of the present invention, a system for managing permission information is provided, which includes a client 81 and a server 82. The client 81 is configured to receive a permission modification instruction, where the permission modification instruction is used to instruct modification of permission information of a file; modify the permission information according to the permission modification instruction of the file; and send an ID of the file and the modified permission information to the server 82. The server 82 is configured to receive the ID of the file and the modified permission information sent by the client 81, query according to the ID whether permission information corresponding to the ID already exists in the server 82, replace the permission information corresponding to the ID with the modified permission information if the permission information corresponding to the ID exists, or store the modified permission information if the permission information corresponding to the ID does not exist.

Implementation of functions of the client in the first embodiment of the system according to the present invention is shown in the detailed description of the first embodiment of the device, and is not repeated herein.

In the system for managing permission information according to the embodiment of the present invention, the server and the file jointly store the permission information, thereby effectively improving the flexibility of file encryption, reducing the burden of the server, and improving the performance of the server.

According to an embodiment of the present invention, a system for managing permission information is further provided. A system block diagram of a second embodiment of the system for managing permission information according to the present invention is the same as the system block diagram of the first embodiment of the system. As shown in FIG. 8, the system includes a client 81 and a server 82. The client 81 is configured to receive an encrypted file, and acquire and send an ID of the file and permission information to the server 82. The server 82 is configured to receive the ID of the file and the permission information sent by the client 81, query whether permission information corresponding to the received ID already exists, perform decryption processing on the permission information corresponding to the ID if the permission information corresponding to the ID already exists, perform decryption processing on the received permission information if the permission information corresponding to the ID does not exist, and send the decrypted permission information to the client 81.

Implementation of functions of the server in the second embodiment of the system according to the present invention is shown in the detailed description of the third embodiment of the device, and is not repeated herein.

In the system for managing permission information according to the embodiment of the present invention, the server and the file jointly store the permission information, thereby effectively improving the flexibility of file encryption, reducing the burden of the server, and improving the performance of the server.

FIG. 9 is a flow chart of a third embodiment of a method for managing permission information according to the present invention. As shown in FIG. 9, according to the embodiment of the present invention, a method for managing permission information is provided, which includes the following steps.

Step 901: Receive a permission modification instruction, where the permission modification instruction is used to instruct modification of permission information of a file.

Step 902: Modify the permission information according to the permission modification instruction of the file.

Step 903: Send an ID of the file and the modified permission information to a server. The server queries according to the ID whether permission information corresponding to the ID already exists in the server, replaces the permission information corresponding to the ID with the modified permission information if the permission information corresponding to the ID exists, or stores the modified permission information if the permission information corresponding to the ID does not exist.

In the embodiment of the present invention, the aforementioned steps may be executed by a client. When an author of a file or a designated user having re-authentication permission to the file intends to modify permission to the file, the author or the user sends a permission modification instruction to the client, and the client modifies permission information according to the permission modification instruction of the file. Then, the ID of the file and the modified permission information are sent to the server. The server stores the latest modified permission information according to the received ID.

In the aforementioned embodiment, the method may further include a step of adding initial permission information into the file, and performing encryption processing on the file. In the step, the encrypted file is divided into two parts. One part is a header file including the initial permission information and the ID of the file, and the other part is contents of the file, so that the file saves the initial permission information.

In the method for managing permission information according to the embodiment of the present invention, the server and the file jointly store the permission information, the initial permission information is stored in the file, and the latest modified permission information is stored in the server, thereby effectively improving the flexibility of file encryption, reducing the burden of the server, and improving the performance of the server.

FIG. 10 is a schematic structure diagram of a fourth embodiment of a device for managing permission information according to the present invention. As shown in FIG. 10, according to the embodiment of the present invention, a device for managing permission information is provided, which includes a third receiving module 1001, a second modification module 1002, and a third sending module 1003.

The third receiving module 1001 is configured to receive a permission modification instruction, where the permission modification instruction is used to instruct modification of permission information of a file. The second modification module 1002 is configured to modify the permission information according to the permission modification instruction of the file received by the second third module 1001. The third sending module 1003 is configured to send an ID of the file and the permission information modified by the second modification module 1002 to a server, so that the server queries according to the ID whether permission information corresponding to the ID already exists in the server, replaces the permission information corresponding to the ID with the modified permission information if the permission information corresponding to the ID exists, or stores the modified permission information if the permission information corresponding to the ID does not exist.

In the embodiment, the device for managing permission information may further include a first processing module, configured to add initial permission information into the file, and perform encryption processing on the file.

In the system for managing permission information according to the embodiment of the present invention, the server and the file jointly store the permission information, the initial permission information is stored in the file, and the latest modified permission information is stored in the server, thereby effectively improving the flexibility of file encryption, reducing the burden of the server, and improving the performance of the server.

Persons skilled in the art may further realize that, in combination with the embodiments herein, units and algorithm steps of each example described can be implemented with electronic hardware, computer software, or the combination thereof. In order to clearly describe the interchangeability between the hardware and the software, compositions and steps of each example have been generally described according to functions in the foregoing descriptions. Whether the functions are executed in a mode of hardware or software depends on particular applications and design constraint conditions of the technical solutions. Persons skilled in the art can use different methods to implement the described functions for each particular application, but it should not be considered that the implementation goes beyond the scope of the present invention.

In combination with the embodiments herein, steps of the method or algorithm described may be directly implemented using hardware, a software module executed by a processor, or the combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

The above descriptions are merely preferred embodiments of the present invention, but are not intended to limit the present invention. Any modification, equivalent replacement, or improvement made without departing from the principle of the present invention should fall within the scope of the present invention.

What is claimed is:

1. A device for managing permission information, comprising: a receiving module, a modification module, and a sending module, wherein:
the receiving module is configured to receive a permission modification instruction, wherein the permission modification instruction is used to instruct modification of permission information of a file;
the modification module is configured to modify the permission information according to the permission modification instruction of the file received by the receiving module; and
the sending module is configured to send an Identifier (ID) of the file and the permission information modified by the modification module to a server, so that the server queries, according to the ID of the file, whether permission information corresponding to the ID of the file already exists in the server, replaces the permission information corresponding to the ID of the file with the modified permission information if the permission information corresponding to the ID of the file exists, or stores the modified permission information if the permission information corresponding to the ID of the file does not exist.

2. The device for managing permission information according to claim 1, further comprising:
a processing module, configured to add initial permission information into the file and to perform encryption processing on the file.

3. A device for managing permission information, comprising:
a receiving module, configured to receive an Identifier (ID) of a file and permission information sent by a client;
a query module, configured to query whether permission information corresponding to the received ID of the file already exists;
a first decryption module, configured to perform decryption processing on the permission information corresponding to the ID of the file if the permission information corresponding to the ID of the file already exists;
a second decryption module, configured to perform decryption processing on the received permission information if the permission information corresponding to the ID of the file does not exist; and
a sending module, configured to send the permission information decrypted by the first decryption module and the second decryption module to the client.

4. A system for managing permission information, comprising:
a client, configured to receive a permission modification instruction, wherein the permission modification instruction is used to instruct modification of permission information of a file, to modify the permission information according to the permission modification instruction of the file, and to send an Identifier (ID) of the file and the modified permission information; and
a server, configured to receive the ID of the file and the modified permission information sent by the client, to query according to the ID of the file whether permission information corresponding to the ID of the file already exists in the server, to replace the permission information corresponding to the ID of the file with the modified permission information if the permission information corresponding to the ID of the file exists, or to store the modified permission information if the permission information corresponding to the ID of the file does not exist.

5. A system for managing permission information, comprising:
a client, configured to receive an encrypted file and to acquire and send an Identifier (ID) of the file and permission information; and
a server, configured to receive the ID of the file and the permission information sent by the client, to query whether permission information corresponding to the received ID of the file already exists, to perform decryption processing on the permission information corresponding to the ID of the file if the permission information corresponding to the ID of the file already exists, to perform decryption processing on the received permission information if the permission information corresponding to the ID of the file does not exist, and to send the decrypted permission information to the client.
